(19) United States
(12) Patent Application Publication
(10) Pub. No.: US 2003/0079708 A1
(43) Pub. Date: May 1, 2003

(54) Die cast cylinder head

(76) Inventors: Patrick J. Bruener, Hartland, WI (US); Norbert M. Vogl, Watertown, WI (US); Gary D. Greenlees, Brookfield, WI (US); Franz Laimboeck, Thal (AT)

Correspondence Address: Casimir F. Laska, Michael Best & Friedrich LLP, 100 East Wisconsin Avenue, Milwaukee, WI, 53202-4108, US

(21) Appl. No.: 10/268,175

(22) Filed: Oct. 10, 2002

Related U.S. Application Data
(60) Provisional application No. 60/346,004, filed on Oct. 26, 2001.

(51) Int. Cl. F02F 1/00

(52) U.S. Cl. 123/193.5

(57) ABSTRACT

A cast cylinder head for an internal combustion engine. The cylinder head includes a first surface, a rear surface, and an intake passageway. The first surface is adapted to be connected to a cylinder housing, and the rear surface extends from the first surface. The intake passageway is in the cylinder head and extends from an inlet on the rear surface toward an outlet on the first surface. The intake passageway includes a straight portion that extends from the rear surface and that includes an axis. The included angle between the axis and the first surface is approximately thirty-five to forty-five degrees.

### FIELD OF THE INVENTION

The invention relates to cylinder heads for internal combustion engines, and more particularly to die cast cylinder heads for internal combustion engines.

### BACKGROUND OF THE INVENTION

Known piston-type internal combustion engines generally include a cylinder housing, a cylinder head, and a cylinder head cover as well as a crankcase. The cylinder head encloses a combustion chamber that is defined at the end of the cylinder housing. Some cylinder heads and cylinder head covers include a cam shaft and rocker arm assembly that is driven by a crankshaft to operate intake and exhaust valves to feed a air/fuel mixture to the combustion chamber and to exhaust combustion gases from the combustion chamber.

Typically, high-speed, high-output cylinder heads are manufactured by a gravity casting process that utilizes sand or degradable cores to create internal coring of the cylinder head. For example, the degradable cores are used to make smoothly curved intake and exhaust ports that communicate with the intake and exhaust valves. The smooth curves in the intake and exhaust ports are important for unrestricted fluid flow and efficient operation of the engine. Specifically, the intake port must be properly configured to maximize power and to create the correct charge motion of the air/fuel mixture in the combustion chamber to increase fuel economy and improve emissions.

Die casting cylinder heads provides a significant cost savings in the manufacture of cylinder heads. But historically die casting of cylinder heads has been disadvantageous because of the inability of the process to successfully core the intake and exhaust ports to a configuration which is necessary to obtain comparable engine efficiencies. In addition, tools used to die cast cylinder heads for use with overhead cams have been limited to casting only a single cylinder head per casting cycle. These tools have been incapable of die casting multiple cylinder heads per cycle because the contour of the cylinder head has required movable slides on all sides.

### SUMMARY OF THE INVENTION

The die cast cylinder head of the present invention decreases the manufacturing costs of the cylinder head by coring the intake and exhaust ports to a substantially finished configuration during the die casting operation. Further, the die cast intake port is angled 40 degrees and the die cast exhaust port is parallel to the base plane of the cylinder head. The die cast ports are operable on high-speed, high-output, single cylinder engines of the type typically used on two wheeled motorized vehicles.

In addition, the cost to manufacture the die cast cylinder head is decreased because the cylinder head is configured to allow multiple cavities within a single tool. Specifically, one side of the cylinder head is contoured such that it can be formed by the separating halves of the tool without the need for independent slides. Since no slide is necessary on one side of the cylinder head, two cavities can be manufactured into the tool by positioning the cylinder heads such that the sides that do not require a slide are adjacent to each other.

One embodiment of the present invention includes a cast cylinder head for an internal combustion engine. The cylinder head includes a first surface, a rear surface, and an intake passageway. The first surface is adapted to be connected to a cylinder housing, and the rear surface extends from the first surface. The intake passageway is in the cylinder head and extends from an inlet on the rear surface toward an outlet on the first surface. The intake passageway includes a straight portion that extends from the rear surface and that includes an axis. The included angle between the axis and the first surface is approximately thirty-five to forty-five degrees.

Another embodiment of the invention includes a cylinder head assembly for an internal combustion engine. The cylinder head assembly includes a cylinder head, a cylinder head cover, a first bearing, a second bearing, and a cam shaft. The cylinder head includes first and second bearing supports. The cylinder head cover is coupled to the cylinder head and includes third and fourth bearing supports. The first bearing is supported by the first bearing support and the third bearing support, and the second bearing is supported by the second bearing support and the fourth bearing support. The cam shaft includes a first portion that is rotatably mounted within the first bearing and a second portion that is rotatably mounted within the second bearing.

Other features and advantages of the invention will become apparent to those skilled in the art upon review of the following detailed description, claims, and drawings.

### BRIEF DESCRIPTION OF THE DRAWINGS

FIG. 1 is a side view illustrating an engine/transmission assembly including a cylinder head embodying the present invention.

FIG. 2 is a cross section view taken along line 2-2 in FIG. 1.

FIG. 3 is a cross section view taken along line 3-3 in FIG. 2.

FIG. 4 is a partial cross section view taken along line 4-4 in FIG. 2.

FIGS. 5-7 are schematic representations of two cylinder heads which are capable of being produced using one die tool and one die casting machine.

FIG. 8 is a cross section view of the cylinder head shown in FIG. 1, illustrating the cylinder head in the “as cast” condition.

FIG. 9 is a view similar to FIG. 8, illustrating the intake and exhaust ports of the cylinder head after machining.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of “consisting of” and variations thereof herein is meant to encompass only the items listed thereafter. The use of letters to identify elements of a method or process is simply for identification and is not meant to indicate that the elements should be performed in a particular order.

### DETAILED DESCRIPTION

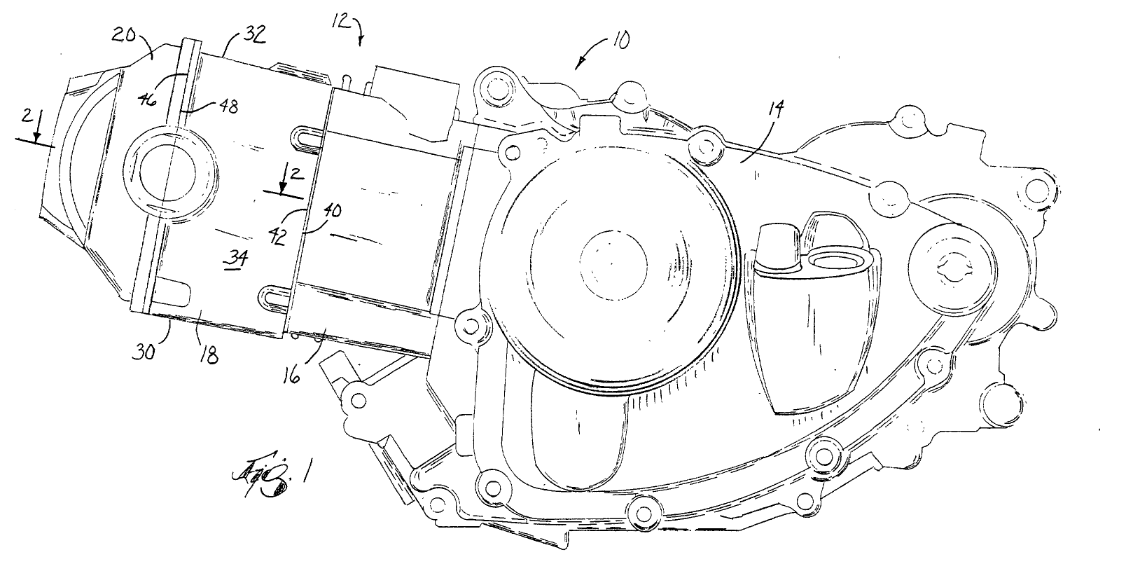

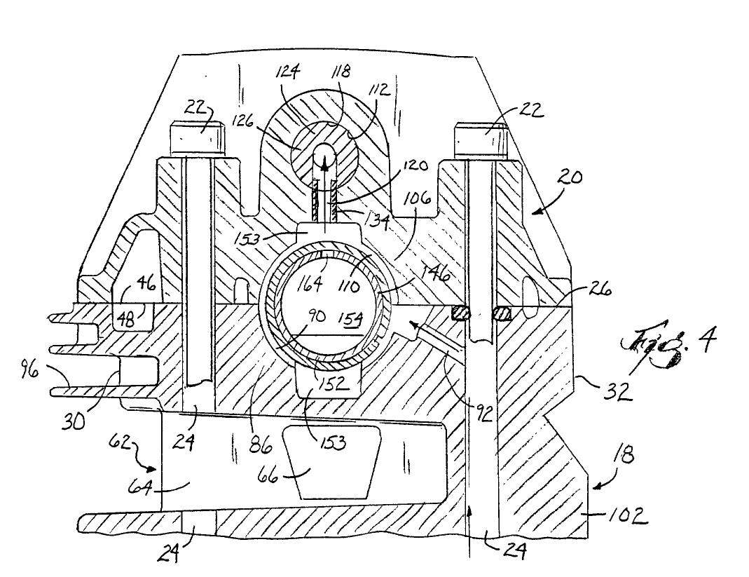

FIG. 1 illustrates an engine/transmission assembly 10 that includes an internal combustion engine 12 having a crankcase 14. The engine 12 includes a cylinder housing 16 connected to the forward portion of the crankcase 14, a cylinder head 18 connected to the cylinder housing 16, and a cylinder head cover 20 connected to the cylinder head 18. The cylinder head cover 20, the cylinder head 18, the cylinder housing 16, and the crankcase 14 are connected with elongated studs 22 that extend from the crankcase 14 through holes 24 located near the outer surfaces of the cylinder housing 16, the cylinder head 18, and the cylinder head cover 20 (FIG. 4).

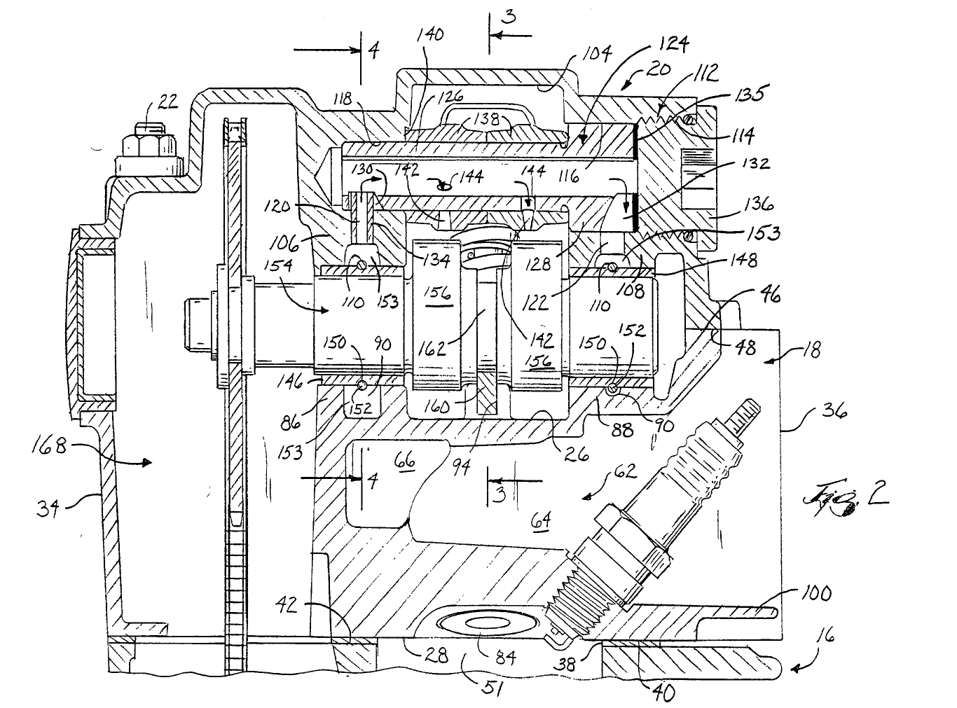

Referring to FIGS. 2-4, the cylinder head 18 includes a top or first surface 26, a bottom or second surface 28, a front face 30, a rear face 32, and first and second side faces 34, 36. The cylinder head 18 is fastened to the cylinder housing 16 such that a gasket 38 is coupled between a planar portion 40 of the bottom surface 28 and a corresponding planar portion 42 of the cylinder housing 16. The planar portion 40 of the bottom surface 28 defines a base plane 44. The cylinder head 18 is fastened to the cylinder head cover 20 such that a planar portion 46 of the top surface 26 of the cylinder head 18 is in contact with a corresponding planar portion 48 of the cylinder head cover 20.

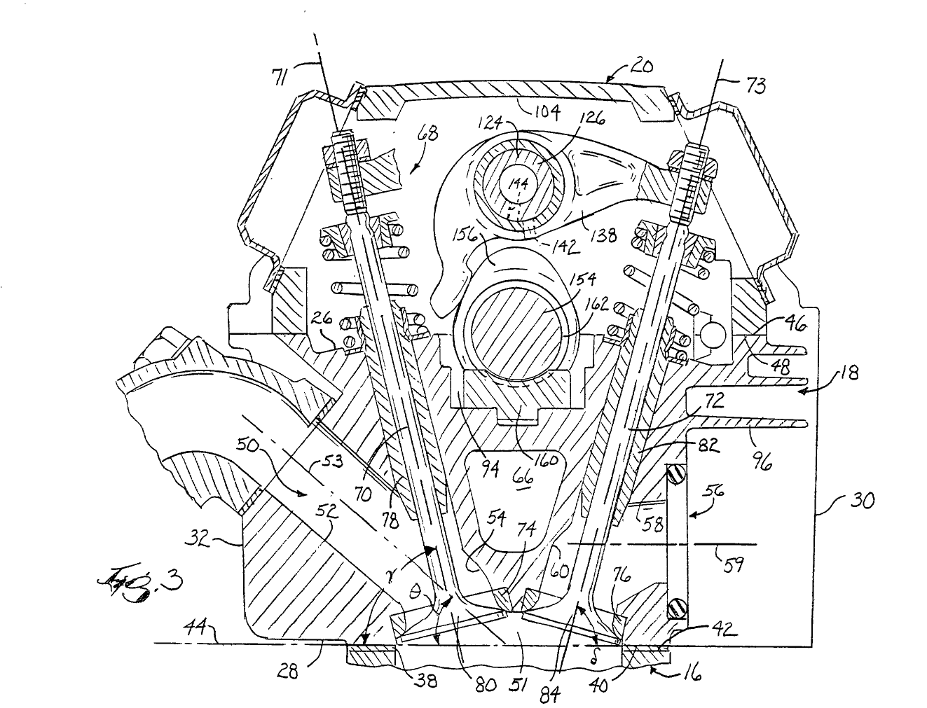

Referring specifically to FIG. 3, the cylinder head 18 further includes an intake port 50 that extends through the cylinder head 18 from the rear face 32 to the bottom surface 28 to communicate with a combustion chamber 51. The intake port 50 includes a straight portion 52 that projects downwardly from the rear face 32 and a curved portion 54 that smoothly transitions from the straight portion 52 to the bottom surface 28 and the intake valve seat 74. The curved portion 54 is preferred, but is not necessarily required. The straight portion 52 projects downwardly from the rear face 32 at approximately an angle θ relative to the base plane 44. Angle θ is the included angle between a longitudinal axis 53 of the straight portion 52 and the base plane 44. The angle θ is preferably between 35 to 45 degrees, and more preferably the angle θ is approximately 40 degrees. The straight portion 52 and curved portion 54 are shaped to provide optimum air flow to the cylinder housing 16 for increased power and responsiveness. The intake port 50 directs the flow in a manner that creates a proper charge motion inside the cylinder housing 16 for increased fuel economy and improved emissions.

The configuration of the intake port 50 is important because it allows the cylinder head 18 to be die cast and provides the proper flow characteristics necessary for power and efficient operation of the engine 12. The straight portion 52 of the intake port 50 can be die cast because the straight portion 52 of the intake port 50 does not require loose cores and can be formed with straight pulling cores. In addition, the critical flow characteristics are maintained by angling the straight portion 52 of the intake port 50 between 35 and 45 degrees.

The cylinder head 18 further includes an exhaust port 56 that extends through the cylinder head 18 from the front face 30 to the bottom surface 28 to communicate with the combustion chamber 51. The exhaust port 56 also includes a straight portion 58 that projects inwardly from the front face 30 and a curved portion 60 that smoothly transitions from the straight portion 58 to the bottom surface 28 and the exhaust seat 76. The straight portion 58 includes a longitudinal axis 59 that is approximately parallel to the base plane 44. The straight portion 58 and the curved portion 60 are configured to reduce the restriction of exhaust gases flowing from the cylinder housing 16 to reduce heat transfer into the cylinder head 18.

The configuration of the exhaust port 56 is substantially less critical to engine performance compared to the configuration of the intake port 50. Since the angle of the exhaust port 56 is not a critical factor, the longitudinal axis 59 of the straight portion 58 of the exhaust port 56 is parallel to the base plane 44 to simplify the die casting process. The casting process is simplified because the straight portion 58 can be formed by the slide of the tool that forms the front face 30 of the cylinder head 18 such that a retractable core similar to the one that forms the straight portion 52 of the intake port 50 is not necessary.

As shown in FIG. 4, the cylinder head 18 further includes a cooling passage 62 that includes first and second portions 64, 66. The first portion 64 extends rearwardly from the front face 30 though a substantial portion of the cylinder head 18. The second portion 66 extends from the second side face 36 and connects with the first portion 64 such that air is allowed to pass through the first and second portions 64, 66 to cool the cylinder head 18. An additional feature of these two passages is that they are shaped to remove a substantial amount of casting material to reduce shrinkage and to improve the life of the tool 170. The boss for stud 22 is partially removed to allow a die casting slide to be retracted (FIG. 4).

Referring back to FIG. 3, the engine 12 includes a valve train 68 that includes an intake valve 70 and an exhaust valve 72. The intake valve 70 includes a longitudinal axis 71 that defines an included angle γ between the longitudinal axis 71 and the base plane 44. The angle γ is preferably between 72 to 82 degrees, and more preferably the angle γ is approximately 77 degrees. The exhaust valve 72 includes a longitudinal axis 73 that defines an included angle δ between the longitudinal axis 73 and the base plane 44. The angle δ is preferably between 58 to 80 degrees, and more preferably the angle δ is approximately 74 degrees. The cylinder head 18 includes first and second valve seats 74, 76 that encircle the intake and exhaust ports 50, 56, respectively, adjacent to the bottom surface 28. The intake valve 70 extends through a first valve bushing 78 and the intake port 50 such that a head 80 of the intake valve 70 is biased upward against the first valve seat 74. The exhaust valve 72 extends through a second valve bushing 82 and the exhaust port 56 such that a head 84 of the exhaust valve 72 is biased upward against the second valve seat 76.

As shown in FIGS. 2 and 4, the top surface 26 of the cylinder head 18 includes first and second lower bearing supports 86, 88. Each of the bearing supports 86, 88 is semi-circular and includes a centrally positioned annular groove 90. The cylinder head 18 includes a lubricant passage 92 that extends from the stud hole 24 to the annular groove 90 of the first lower bearing support 86 (FIG. 4). The top surface 26 also includes a slot 94 that is positioned between the lower bearing supports 86, 88 (FIGS. 2 and 3).

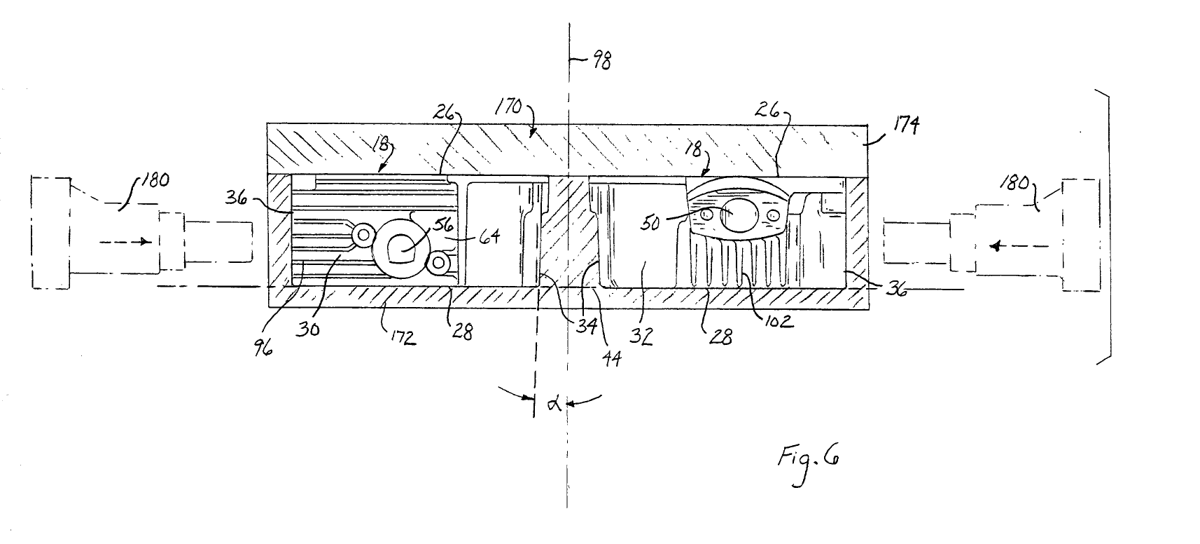

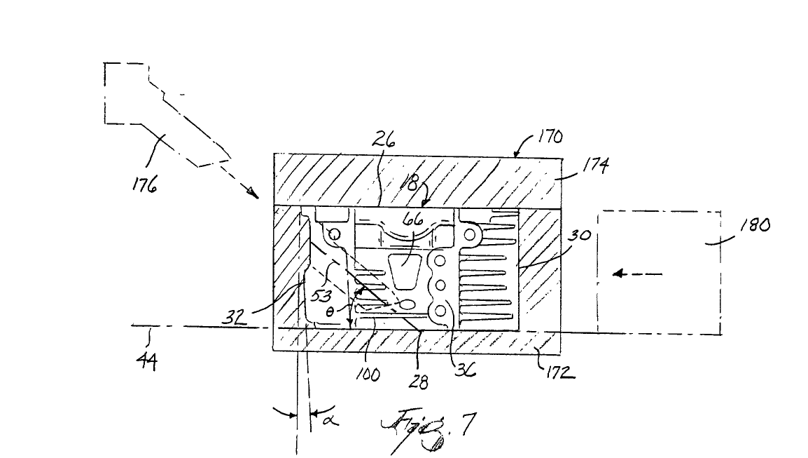

As best shown in FIGS. 6 and 7, the front face 30 includes a plurality of forwardly extending horizontal cooling fins 96 that partially wrap around the corner of the cylinder head 18 to cover a portion of the second side face 36. The first side face 34 is angled by a draft angle α relative to a vertical axis 98 that is perpendicular to the base plane 44. The second side face 36 includes a plurality of forwardly extending horizontal cooling fins 100. The rear face 32 includes a plurality of rearwardly extending vertical cooling fins 102. Cooling fins have been historically positioned so that they are all parallel to the direction of cooling air flow. The cooling fins 96, 100 on the front and side faces 30, 36 are transverse to the cooling fins 102 on the rear face 32. Although the direction of the fins 96, 100, 102 is varied, the fins 96, 100, 102 remove a sufficient amount of heat from the cylinder head 18 compared to fins that are all aligned in the same direction. The vertical fins 102 of the rear face 32 and the draft angle α of the first side face 34 provide a tooling advantage which will be explained in more detail below. In addition, the fins 96, 100, 102 allows the engine 12 to be cooled by a natural draft when the engine 12 is exposed and allows the engine 12 to be fan cooled when the engine 12 is enclosed within a cover (not shown) such as on a scooter, for example.

Referring again to FIGS. 2 and 4, the cylinder head cover 20 includes a bottom surface 104. The bottom surface 104 includes first and second upper bearing supports 106, 108. Each of the bearing supports 106, 108 is semi-circular and includes a centrally positioned annular groove 110. The cylinder head cover 20 also includes a rocker shaft bore 112 that extends from a side of the cylinder head cover 20 toward the opposite side of the cylinder head cover 20. The rocker shaft bore 112 includes a threaded portion 114 adjacent to the opening of the rocker shaft bore 112 and a proximate portion 116 that is adjacent to the threaded portion 114. The rocker shaft bore 112 also includes a distal portion 118 that has a diameter that is smaller than the diameter of the proximate portion 116. The cylinder head cover 20 includes a first lubricant passage 120 that fluidly connects the annular cavity of the first upper bearing support 106 to the distal portion 118 of the bore 112, and a second lubricant passage 122 that fluidly connects the annular cavity of the second upper bearing support 108 to the proximate portion 116 of the bore 112.

The engine 12 includes a hollow rocker shaft 124 that is inserted into the rocker shaft bore 112. The rocker shaft 124 includes a shaft portion 126 and a head portion 128. The rocker shaft 124 includes a first lubricant opening 130 on the distal end of the shaft portion 126 and a second lubricant opening 132 on the proximate end of the head portion 128. The shaft portion 126 is positioned within the distal portion 118 of the rocker shaft bore 112 and the first lubricant opening 130 is in fluid communication with the first lubricant passage 120. The head portion 128 is positioned within the proximate portion 116 of the rocker shaft bore 112 and the second lubricant opening 132 is in fluid communication with the second lubricant passage 122. An insert 134 is positioned in the first lubricant passage 120 and through the first lubricant opening 130 to align the lubrication openings 130, 132, 144 and prevent the rotation of the rocker shaft 124. A threaded plug 136 and wave washer 135 are inserted into the threaded portion 114 of the rocker shaft bore 112 to maintain the rocker shaft 124 within the rocker shaft bore 112 and to locate it inwardly against the end of the bore 118 so that end play of the rocker arms 138 can be controlled.

The engine 12 also includes rocker arms 138 that are pivotably connected to the shaft portion 126 of the rocker shaft 124 between a facing 140 on the cylinder head cover 20 and the head portion 128 of the rocker shaft 124. The rocker arms 138 are coupled to respective valves 70, 72 and include lubrication holes 142 (FIGS. 2 and 3). The lubrication holes 142 of the rocker arms 138 align with lubrication holes 144 of the rocker shaft 124 when the rocker arms 138 are in a specific angular position relative to the rocker shaft 124 (FIG. 3).

With reference to FIGS. 2 and 4, the engine 12 further includes first and second cam bearings 146, 148 that include annular grooves 150 that are centrally located on the outside diameter of the cam bearings 146, 148. Each cam bearing 146, 148 includes an annular ring 152 that is biased within the annular groove 150 of the cam bearing 146, 148. The first cam bearing 146 is coupled between the first lower and upper bearing supports 86, 106 and the second cam bearing 148 is coupled between the second lower and upper bearing supports 88, 108 such that the annular ring 152 is positioned within the annular grooves 90, 110 of the upper and lower bearing supports 86, 88, 106, 108. The annular rings 152 axially locate the cam bearings 146, 148 with respect to the upper and lower bearing supports 86, 88, 106, 108 and prevent axial movement of the cam bearings 146, 148. An additional feature of the annular grooves 90, 110 is that they reduce casting material. Rectangular pockets 153 are added to the grooves to further reduce the amount of casting material to reduce shrinkage and improve the life of the tool 170 (FIGS. 2 and 4).

The engine 12 also includes a cam shaft 154 that is inserted within and rotatably coupled to the first and second cam bearings 146, 148. The cam shaft 154 includes lobes 156 that slidably engage the rocker arms 138 such that rotation of the cam shaft 154 pivots the rocker arms 138 and moves the intake and exhaust valves 70, 72. As illustrated in FIGS. 2 and 3, the cam shaft 154 is prevented from axial movement by a key 160 that is inserted in the slot 94 of the cylinder head 18. The key 160 extends upward into an annular groove 162 in the cam shaft 154 between the cam lobes 156. The key is a loose piece and is not fastened in place with a fastener, but instead is maintained in position by the annular groove 162 of the cam shaft 154 and the slot 94 of the cylinder head 18.

The lubrication of the cylinder head 18 and cylinder head cover 20 is described with reference to FIGS. 2 and 4. A pump (not shown), pumps a lubricant from the crankcase 14 up through the cylinder head 18 by forcing lubricant through a clearance between the stud 22 and stud hole 24. Once the lubricant reaches the cylinder head 18, the lubricant flows through the lubricant passage 92 and into the annular grooves 90, 110 to lubricate the cam shaft 154 through a hole 164 in the first cam bearing 146. From the annular grooves 90, 110, the lubricant flows through the first lubrication opening 130 and into the hollow rocker shaft 124. The lubricant in the hollow rocker shaft 124 intermittently lubricates the rocker arms 138 and cam lobes 156 through the lubrication holes 142, 144 when the rocker arms 138 are in a specific position relative to the rocker shaft 124. The remaining lubricant in the rocker shaft 124 flows across the rocker shaft 124, through the second lubrication opening 132 and lubrication passage 122 and into the annular grooves 90, 110 to lubricate the cam shaft 154 through a hole (not shown) in the second cam bearing 148. After the lubricant is diverted throughout the cylinder head 18, it accumulates on the top surface 26 of the cylinder head 18 until it overflows into a chain cavity 168 of the cylinder head 18 and down the chain cavity 168 into the crankcase 14.

Although the bearings 146, 148 may rotate within the bearing supports 86, 88, 106, 108, the cam shaft 154 continues to be properly lubricated because the lubricant flows throughout the annular grooves 90, 110 and therefore the angular position of the cam bearing holes 164 is not critical.

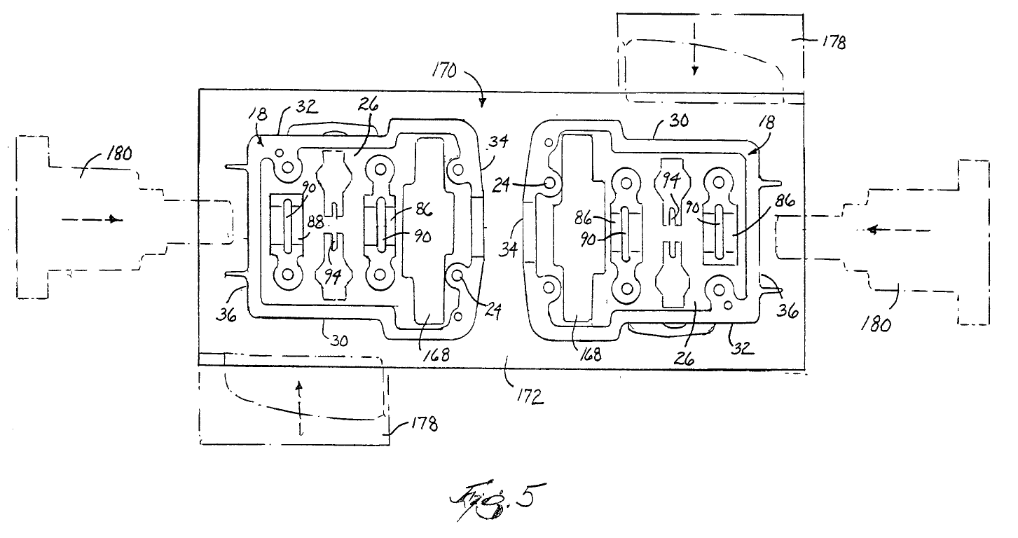

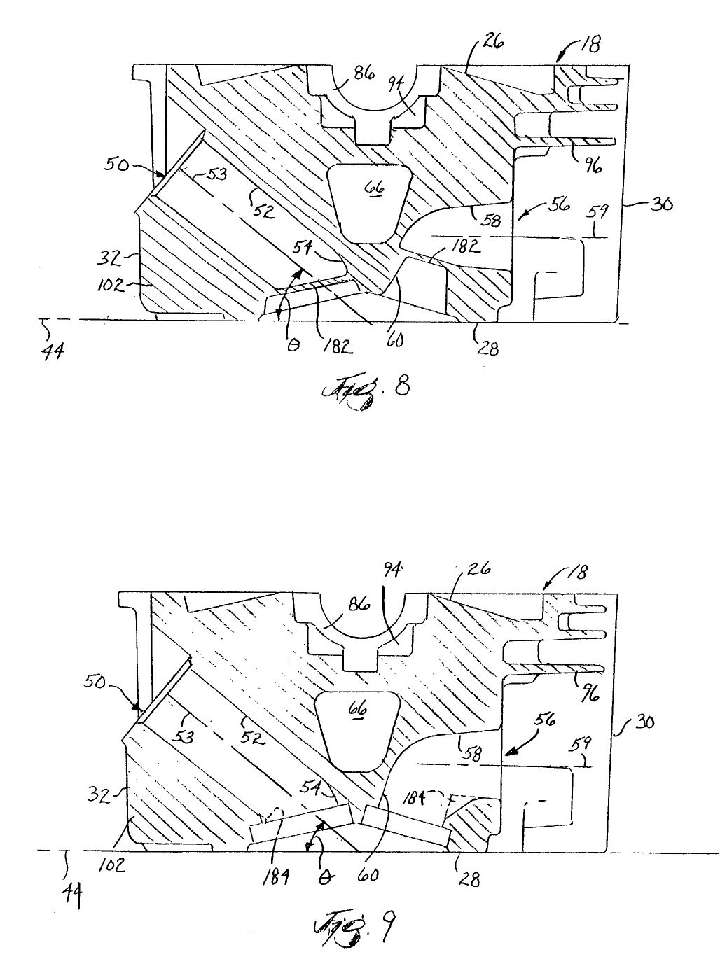

The cylinder head 18 is die cast, and is capable of being die cast in a two cavity tool 170 as shown in FIG. 5. FIG. 5 illustrates a stationary side 172 of the tool 170 with two die cast cylinder heads 18 positioned within the tool 170. As shown in FIG. 8 the stationary side 172 of the tool 170 forms the cast shape of the bottom surface 28 of the cylinder head 18 including portions of the intake and exhaust ports 50, 56.

Referring to FIGS. 6-7, the tool 170 includes an ejector side 174 that mates with and that is movable with respect to the stationary side 172 of the tool 170. The ejector side 174 forms the cast shape of the top surface 26 of the cylinder head 18 including the chain cavity 168, first and second lower bearing supports 86, 88, and the annular grooves 90. The ejector side 174 of the tool 170 also includes a core 176 that is moveable with the ejector side 174 of the tool 170. The core 176 is extendable to form the straight portion 52 of the intake port 50 (FIG. 8) and retractable such that the cast cylinder head 18 can be removed from the tool 170.

As shown in FIGS. 5-7, the front face 30 of the cylinder head 18 is created by a first slide 178 and the second side face 36 is created by a second slide 180. The first slide 178 forms the horizontal fins 96, the straight portion 58 of the exhaust port 56, and the first portion 64 of the cooling passage 62. The second slide 180 forms the horizontal fins 100 and the second portion 66 of the cooling passage 62.

The rear face 32 of the cylinder head 18 does not use a slide to form the fins 102 and contour. Instead, the vertical fins 102 of the rear face 32 are capable of being formed by the stationary side 172 of the tool 170, and therefore no slide is necessary which would otherwise interfere with the operation of the core 176 that forms the straight portion 52 of the intake port. In other words, the contour and fins 102 of the rear face 32 are capable of being formed by a coreless tool. The portions of the rear face 32 which are created by the stationary side 172 of the tool 170 are angled relative to the vertical axis 98 by the draft angle α. As shown in FIGS. 6 and 7, the draft angle α is approximately 2 degrees relative to the vertical axis 98. The draft angle α can be as small as 0.5 degrees while still allowing the cast cylinder head 18 to be removed easily from the tool 170.

The first side face 34 of the cylinder head 18 is formed without the use of slides or cores (i.e., with a coreless tool). Rather, the first side face 34 is formed by the stationary and ejector sides 172, 174 of the tool 170. Because the first side face 34 is formed without using slides, the tool 170 is capable of having two cavities that are 180 degrees relative to each other so that the tool 170 can cast two cylinder heads 18 in the same cycle. Specifically, the first side face 34 of a first cast cylinder head 18 is positioned adjacent to the first side face 34 of a second cast cylinder head 18. In contrast, if all of the faces 30, 32, 34, 36 required slides, the equipment used to actuate the slides would prevent multiple cavities from being positioned together because the slides of one cavity would interfere with the slides of the adjacent cavity.

The cast shape of the cylinder head 18 is illustrated in FIG. 8. The intake and exhaust ports 50, 56 are cast with dividers 182 that allow casting alloy to flow therethrough. The cast shape is a near net cast shape which requires only minor machining where tolerances are critical. This is a significant cost savings because less material needs to be removed during machining operations. In addition, where the tolerances are not critical, the features of the cylinder head 18 need not be machined at all and can be utilized in the cast condition.

FIG. 9 illustrates machined intake and exhaust ports 50, 56 of the cylinder head 18 with the intake and exhaust ports 50, 56 in their final operable form. The machining involves plunging a ball end mill through the dividers 182 to open the intake and exhaust ports 50, 56. This machining step leaves sharp comers 184 on the interior bend where the straight portion 52, 58 transitions into the curved portions 54, 60. The sharp corner 184 on the intake port 50 can prevent the charge from correctly flowing into the cylinder housing 16, and the sharp comer 184 on the exhaust port 56 increases heat transfer to the cylinder head 18 and restricts the flow of the exhaust gases. Additional precision machining removes the sharp corners 184 from the intake and exhaust ports 50, 56 to improve the efficiency of the engine 12, to improve the flow characteristics of the intake and exhaust ports 50, 56, and to reduce the operating temperature of the cylinder head 18 charge and the exhaust gases.

We claim:

1. A cast cylinder head for an internal combustion engine, the cylinder head comprising:
a first surface adapted to be positioned adjacent to a cylinder housing, the first surface having an outlet therein;
a rear surface extending from the first surface, the rear surface having an inlet therein; and
an intake passageway in the cylinder head that extends from the inlet in the rear surface toward the outlet in the first surface, the intake passageway including a straight portion extending from the rear surface, the straight portion including an axis, the included angle between the axis and the first surface being approximately thirty-five to forty-five degrees.

2. The cast cylinder head of claim 1, wherein the included angle is approximately forty degrees.

3. The cast cylinder head of claim 1, further comprising an intake valve in communication with the intake passageway, wherein the intake valve defines a valve axis, and wherein the included angle between the valve axis and the first surface is approximately seventy-two to eighty-two degrees.

4. The cast cylinder head of claim 3, wherein the included angle between the valve axis and the first surface is approximately seventy-seven degrees.

5. The cast cylinder head of claim 1, wherein the intake passageway includes a curved portion connecting the straight portion and the outlet.

6. The cast cylinder head of claim 1, further comprising
a forward surface extending from the first surface, and
an exhaust passageway in the cylinder head that extends from a second inlet in the forward surface to a second outlet in the first surface, the exhaust passageway including a second straight portion extending from the second inlet, the second straight portion including a second axis, the second axis being approximately parallel to the first surface.

7. The cast cylinder head of claim 6, wherein the forward surface includes cooling fins that are parallel to the first surface.

8. The cast cylinder head of claim 1, wherein the rear surface includes cooling fins that are transverse to the first surface.

9. The cast cylinder head of claim 1, further comprising a second axis normal to the first surface, wherein the rear surface includes a drafted portion capable of being formed by a coreless tool.

10. The cast cylinder head of claim 1, further comprising a side surface extending from the first surface and a second axis normal to the first surface, wherein the side surface includes a drafted portion capable of being formed by a coreless tool.

11. The cast cylinder head of claim 1, further comprising a second surface offset from the first surface, the second surface including at least one bearing support.

12. A cylinder head assembly for an internal combustion engine, the cylinder head assembly comprising:
a cylinder head including first and second bearing supports;
a cylinder head cover coupled to the cylinder head and including third and fourth bearing supports;
a first bearing supported by the first bearing support and the third bearing support;
a second bearing supported by the second bearing support and the fourth bearing support; and
a cam shaft including a first portion that is rotatably mounted within the first bearing and a second portion that is rotatably mounted within the second bearing, wherein the first and third bearing supports define a first annular groove and the second and fourth bearing supports define a second annular groove.

13. The cylinder head assembly of claim 12, wherein the cam shaft includes an external groove, and wherein the cylinder head assembly further comprises a key coupled to the cylinder head and slidably coupled to the cam shaft within the external groove.

14. The cylinder head assembly of claim 12, further comprising
a first annular ring coupled to the first bearing, and
a second annular ring coupled to the second bearing, wherein the first annular ring is positioned at least partially within the first annular groove and the second annular ring is positioned at least partially within the second annular groove.

15. The cylinder head assembly of claim 14, wherein the cylinder head includes a passageway fluidly connected to the first annular ring.

16. The cylinder head assembly of claim 12, further comprising a hollow rocker shaft supported by the cylinder head cover, wherein the rocker shaft includes a first lubrication opening, and wherein the cylinder head cover includes a first lubricant passage that fluidly connects the first annular groove with the first lubrication opening.

17. The cylinder head assembly of claim 16, further comprising an insert within the first lubrication opening and the first lubricant passage.

18. The cylinder head assembly of claim 16, wherein the rocker shaft includes a second lubrication opening, and wherein the cylinder head cover includes a second lubricant passage that fluidly connects the second lubrication opening with the second annular groove.

19. The cylinder head assembly of claim 12, further comprising a rocker shaft supported by the cylinder head cover, and a first rocker arm pivotable about the rocker shaft, the first rocker arm having a first hole, wherein the cam shaft includes a first cam lobe that engages the first rocker arm, and wherein the rocker shaft includes a first lubrication hole, the first lubrication hole adapted to intermittently align with the first hole.

20. The cylinder head assembly of claim 19, further comprising a second rocker arm pivotable about the rocker shaft, the second rocker arm having a second hole, wherein the cam shaft includes a second cam lobe that engages the second rocker arm, and wherein the rocker shaft includes a second lubrication hole, the second lubrication hole adapted to intermittently align with the second hole.

21. A cylinder head assembly for an internal combustion engine, the cylinder head assembly comprising:
a cylinder head;
a cylinder head cover coupled to the cylinder head;
a rotatable cam shaft; and
a rocker shaft supported by the cylinder head cover, and
a first rocker arm pivotable about the rocker shaft, the first rocker arm having a first hole, wherein the cam shaft includes a first cam lobe that engages the first rocker arm, and wherein the rocker shaft includes a first lubrication hole, the first lubrication hole adapted to intermittently align with the first hole.

22. The cylinder head assembly of claim 21, further comprising a second rocker arm pivotable about the rocker shaft, the second rocker arm having a second hole, wherein the cam shaft includes a second cam lobe that engages the second rocker arm, and wherein the rocker shaft includes a second lubrication hole, the second lubrication hole adapted to intermittently align with the second hole.
